(19) United States
(12) Patent Application Publication
(10) Pub. No.: US 2006/0020487 A1
(43) Pub. Date: Jan. 26, 2006

(54) Parking fee system and method

(76) Inventors: David Spittel, West Vancouver (CA); Darren Stone, Vancouver (CA); Desmond Griffin, Vancouver (CA)

Correspondence Address: SONNABENDLAW, 600 PROSPECT AVE, BROOKLYN, NY, 11215, US

(21) Appl. No.: 11/154,358

(22) Filed: Jun. 15, 2005

Related U.S. Application Data
(60) Provisional application No. 60/581,241, filed on Jun. 18, 2004.

(51) Int. Cl. G06Q 99/00

(52) U.S. Cl. 705/1

(57) ABSTRACT

A comprehensive, integrated system for management of fee for parking businesses, including payment collection and processing for these business, as well as other businesses to which such a system may be applicable.

### CROSS REFERENCE TO RELATED APPLICATIONS

This application claims priority to U.S. application 60/581,241, filed Jun. 18, 2004.

### BACKGROUND OF THE INVENTION

1. Field of the Invention

The present invention relates generally to the field of payment collection and processing, and more specifically to the payment collection and processing for automobile parking fees and the like. The present invention further relates to the field of fee for parking business management.

2. Background of the Related Art

Management of fee for parking businesses, including payment collection and processing, is presently labor intensive. Many systems currently utilized by managers are “pencil and paper” based systems, that is, they rely on paper-based forms and filing systems manually completed by individuals. Other present systems may employ computers to help reduce the amount of labor required for management; however, the current systems achieve a low level of automation, in part due to a lack of integration between various portions of the management process and/or a lack of sufficient business intelligence inherent in the computer systems.

With these considerations in mind, it is desirable to have a comprehensive, integrated system for management of fee for parking businesses, including payment collection and processing for these business, as well as other businesses to which such a system may be applicable.

### SUMMARY OF THE INVENTION

The subject invention is directed to a comprehensive, integrated system for management of fee for parking businesses, including payment collection and processing for these business, as well as other businesses to which such a system may be applicable.

The present invention generally covers, among others, four principal areas: (1) automated meter performance monitoring (including out of order meter monitoring); (2) automated fee and violation payment; (3) digital permitting and permit validation; and (4) electronic and remote validation.

The present invention may include a backend database which may be an SQL based database such as Oracle Corporation's Oracle Database 10g, which may run on a Linux operating system on a standard Intel or AMD processor based computer. Additionally, the present invention may include a user interface “front end”, which may be implemented using a web server/web browser architecture. The functionality of the web server may be programmed using any appropriate language or scripting language, including among others, C#, C, C++, ASP, Java, JavaScript, Visual Basic, Perl, PHP and others. Furthermore, the present invention may utilize handheld, wireless devices such as “personal digital assistants”, including devices utilizing the PalmSource Inc.'s Palm Operating System (such as those devices manufactured by PalmOne Inc.), devices utilizing Microsoft Corp.'s PocketPC, Windows CE or other Windows operating systems (such as those devices manufactured by the Hewlett-Packard Development Company), or cell phone and pager type devices. These wireless devices may communicate with other components of the instant invention via wired or wireless local area or wide area networks, or via the internet, and may utilize ethernet, WiFi (802.11x), CDPD, or other similar networks or combinations thereof.

Automated Meter Performance Monitoring

The first principal area, automated meter performance monitoring (including out of order meter monitoring), provides a system and method for monitoring the performance of parking meters and similar mechanisms to ensure that they are operating properly. The system and method includes monitoring of such mechanisms to determine whether or not units have failed (that is, are broken or otherwise “out of order”). Among other features of this aspect of the instant invention, the disclosed system and method facilitate responses to customer calls concerning improperly function or non-functioning mechanisms. In this regard, the system may provide a call answering service by which customers (that is, persons desiring to use the mechanism) may contact the operator of the mechanism. These call answering service may operate 24 hours per day, seven days per week or some lesser time. The call answering service may also facilitate customer payment for parking or other services associated with the defective mechanism, or payment of customer refunds for improper charges associated with a defective mechanism.

Additionally, the system may provide means for logging information pertaining to the mechanism at issue, including among other information, the identity of the mechanism at issue (by ID number, location or other means), the nature of the defect or operational failure, the time and date of the defect or operational failure, and the like.

The system may also facilitate the dispatching of repair and/or maintenance personnel (collectively “repair personnel” or “maintenance personnel”) to repair or maintain various mechanisms. The system may contact repair personnel via electronic messaging such as instant text messaging, facilitating communication with repair personnel already “in the field” and obviating the need for such repair personnel to return to office locations to receive information regarding malfunctioning or otherwise broken mechanisms. The system may also permit repair personnel to update in real time the status of mechanism repair or maintenance without the need to return to physical office locations or to complete and file written repair status forms, thereby permitting managers to monitor system wide mechanism status remotely in real time. Additionally, the system may facilitate the scheduling of repair personnel based on availability, geographic and temporal proximity to specific mechanisms, severity of mechanism malfunction, relative priority of mechanism repairs and the like.

Finally, the system may facilitate mechanism auditing and reporting by maintaining ongoing historical mechanism usage, maintenance and repair data, thereby permitting managers to continually assess the overall state of their operations. By this, managers may assess issues such as the existence and location of “problem areas”, profitability of business operations by area or other parameter, reliability of various mechanisms and the like.

Automated Fee and Violation Payment

The second principal area provides an automated fee and violation payment system, that is, a system by which the payment of fees and payment of violations may be automated. The present invention may facilitate the electronic presentation of fees, in the form of invoices or otherwise. This presentation may be via a web-based interface or other computer interface, and may be presented on any appropriate device, including a personal computer, hand held computer (e.g., a “personal digital assistant”) or other device. Similarly, wireless communications devices such as cell phones and pagers, among others, may be utilized to present the information.

The present invention may further permit the payment of fees and/or violations via an electronic interface such as those just described. Payments may be made by credit card, electronic funds transfer, by debit from a privately maintained account (e.g., a debit account maintained by a fee for parking business) or by any other available means. Payments may be initiated using a provided graphical user interface or by a voice or touch tone (i.e., DTMF or similar technology) response system.

The system may present and apply various discounts to users.

For managers, the present invention may provide bookkeeping and related functionality based on historical records of transactions. The instant invention may permit managers to reconcile statements, prepare financial reports and the like without the need to re-enter financial or other transactional data into a spreadsheet or other financial computer program. Additionally, the present invention may provide managers with real time information regarding payments and the like that have been or are being processed by the system.

Digital Permitting and Permit Validation

The third principal area of the present invention is digital permitting and permit validation. The present invention may facilitate the issuance of parking permits and other similar permits, and may further facilitate the validation of such permits previously issued. Traditionally, institutions which issue permits such as parking permits, require applicants for such permits to manually apply for such permits and to receive and utilize physical indicators of the permit such as window decals or “hang tags” designed to be hung from automobiles' rear view mirrors. The instant invention facilitates the submission of applications via computers or other networked electronic devices. The present invention may provide automated application review and associated acceptance and/or denial of applications. The present invention may also facilitate payment for permit fees as described above, and may contact permittees electronically or otherwise with messages relating to permit status, e.g., sending renewal notices to permittees.

The instant invention also may automatically maintain records of issued permits. In connection with this, the instant invention may obviate the need for physical indicators of valid permits, permitting field personnel to validate the existence of permits based on data maintained by the instant invention such as license plate numbers for validly permitted cars. The field personnel may use wireless devices such as those discussed above to query the system regarding specific vehicles and may take appropriate action based on the results of the queries.

The instant invention may be applicable not only in the context of permitting such as for monthly parking permitting, but also in connection with specific events. The instant invention may provide VIP event parking, event ticket sales and the like.

Additionally, the present invention may facilitate the management of parking or other permitted resources by correlating resource data with usage information created and maintained during the permitting process. For example, a system in accordance with the instant invention may be programmed with parking space resource data. The system may continuously compare the number of issued, unexpired parking permits against the total inventory of parking spaces available. The system may then refuse to issue further permits when a certain maximum ratio of permits to parking spaces is reached.

Electronic and Remote Validation

The final principal area of the instant invention is electronic and remote validation. The instant invention may facilitate parking validations,,for example, in hotel parking lots, without the need for traditional paper based parking vouchers or voucher books.

The instant invention may facilitate validations by providing an electronic system for creating and maintaining validation data. The system may provide a web based or other user interface through which users may issue and rescind validations, as well as determine validation status of previously issued validations. The system may facilitate the issuance of partial or full validations.

The instant invention may provide a user interface by which users may login to a validation system. The login process may require a user name and/or user pin (i.e., password or “personal identification number”). The user may be permitted to enter parking customer information such as license plate numbers, parking space identifiers, as well as other, similar data. The instant invention may utilize the information provided by users to generate validation data, including among others, validation costs, fees, durations and other conditions of validation. The instant invention may also provide validation activation and confirmation via wireless or other handheld or computer device as described in detail above in connection with the other principal areas.

These and other aspects of the subject invention will become more readily apparent to those having ordinary skill in the art from detailed descriptions of the invention taken in conjunction relevant drawings.

### BRIEF DESCRIPTION OF THE DRAWINGS

So that those having ordinary skill in the art to which the subject invention pertains will more readily understand how to make and use the subject invention, preferred embodiments thereof will be described in detail herein with reference to the drawings.

FIG. 1 is a schematic diagram of an embodiment of the Meter Out of Order system of the present invention.

FIG. 2 is a flowchart for processing customer calls in a preferred embodiment of the present invention.

FIG. 3 is a flowchart for processing incidents in a preferred embodiment of the present invention.

FIG. 4 is a flowchart for payment processing in a preferred embodiment of the present invention.

FIG. 5 is a flowchart for processing technician calls in a preferred embodiment of the present invention.

FIG. 6 is a schematic diagram of the database structure of a preferred embodiment of the present invention.

FIG. 7a-c is a table describing the database tables of a parking permitting database of a preferred embodiment of the present invention

FIG. 8a-e is a computer code listing of a database structure for a database of a preferred embodiment of the present invention.

FIG. 9a-f is a computer code listing of a database structure for a parking permitting database of a preferred embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. The present invention may be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, a transmission media such as those supporting the Internet or an intranet, or magnetic storage devices.

It will be understood that the terms “parking lots”, “lots” and the like as used herein do are not limited to physical parking lots, but to any system or collection of managed parking resources, for example, a system of municipally controlled on street, metered parking spaces. The functionality of the various modules and components discussed herein may be combined, split, or provided for in modules different than those disclosed herein without departing from the present invention.

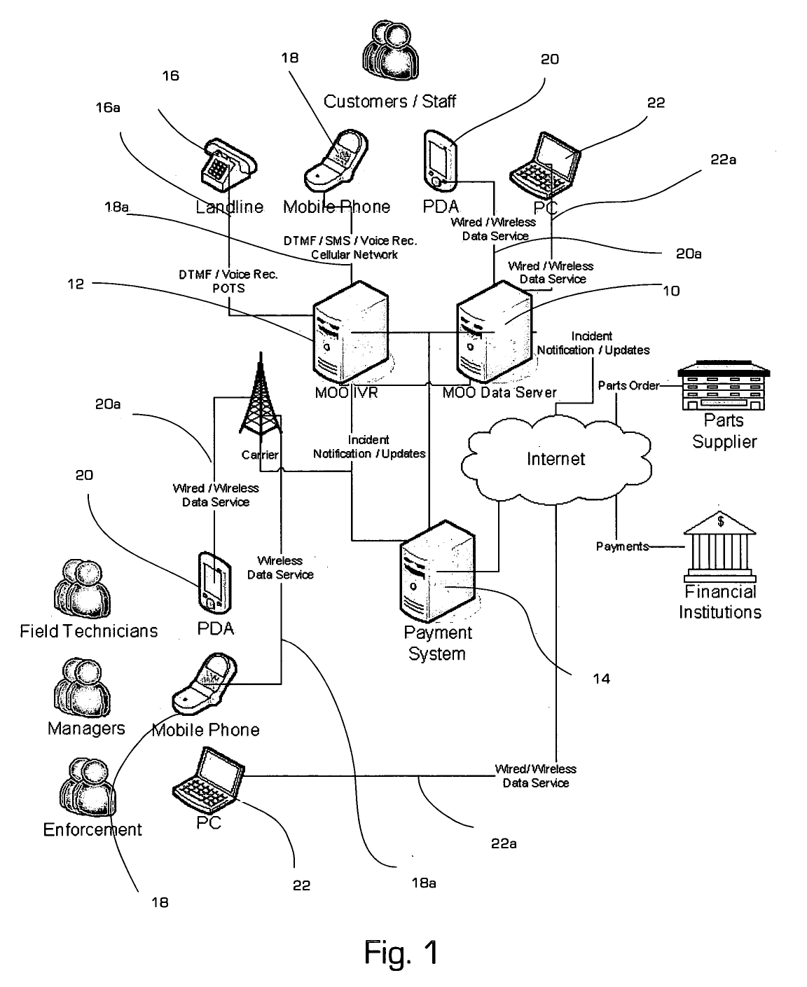

FIG. 1 is a schematic diagram of an embodiment of the Meter Out of Order system of the present invention. It is to be understood that references to “meter out of order system” and like herein include other meter performance monitoring, as has been previously discussed, and meters may be considered “out of order” if partially or completely malfunctioning.

A data server module 10 provides database functionality for the system of the present invention as described more fully below. Data server module 10 may be any suitable host computer, whether shared or dedicated, or similar device and may utilize any commercially available database program such as PostGRE SQL, (available at www.postgresql.com), mySQL (MySQL AB, Bangardsgatan 8, S-753 20 Uppsala, Sweden), Oracle Databases, including Oracle Database 10g (Oracle, 500 Oracle Parkway Redwood Shores, Calif.) and others. The preferably may employ structured query language, but other database access methodologies may also be employed without departing from the instant invention. The database preferably implements multiple concurrent user access to permit multiple transactions to be processed simultaneously, although such access is not necessary to practice the present invention.

The data server module 10 may also contain program logic for providing other system functionality, such as input based decision making as described herein in connection with the various flowcharts contained in the figures.

The data server module 10 is depicted in FIG. 1 as comprising a single host computer; however, the data server may be comprised of several such host computers in order to achieve adequate performance as system size increases. Similarly, so called “n-tiered” database implementation, that is, an implementation in which database functionality is distributed across. various modules, may also be beneficially applied as will be readily understood by those of skill in the art.

The database maintained by the data server module 10 contains, in part, data pertinent to the meter operation, monitoring and repair. The partial database structure of a preferred embodiment of the present invention is disclosed in FIG. 6 and Appendix A hereto, and references to various table, field and index names may be understood with reference thereto. Those of ordinary skill in the art will readily understand the nature of the data contained in each table of the database and the various relationships between the tables from the diagrams and appendix just mentioned. Likewise, those of ordinary skill in the art will readily by able to implement the database structure disclosed. The following discussion, therefore, merely amplifies certain aspects of the database otherwise disclosed, and reference numbers are with reference to FIG. 6.

First, each record in table WPPARKING_LOTS , 70, contains information regarding an individual parking lot maintained by the system. Each parking lot is assigned a unique identifier, which is stored in the LOT_UID field. Vendor (i.e., lot owner or operator) information is maintained in a separate table, not shown, and any individual vendor's population of parking lots may be determined by constructing a proper joined query or other relation-based construct between WPPARKING_LOTS and the vendor table. The relationship may be one-to-many, utilizing a foreign key in WPPARKING_LOTS to relate records therein to records in the vendor table, or the relationship may be many to many, implemented via an intermediate, relation table such as WPPARKING_VENDOR_LOTS, 71

Parking rate information for various rate types may be stored in a table such as WPPARKING_RATES 72 and related to individual lots in the same manner as described for vendors, utilizing relation table WPPARKING_LOT_RATES 73 for many to many relationships.

Information regarding various parking meter issue types, that is, types of meter malfunctions, may be stored in a table dedicated to that purpose, such as WPPARKING_VENDOR_METERISSUETYPES. In the embodiment depicted, WPPARKING VENDOR_METERISSUETYPES includes field VENDOR_UID so that each issue types may be associated with different vendors, thus allowing different vendors to have differing issue types pertinent to their particular type of meter equipment utilized.

Information regarding individual meter incidents may be stored in WPPARKING_METERREPAIR table 77, where each “incident” is defined as a meter in need of repair. Each time a malfunction is reported regarding a meter, a meter “issue” record is created, as will be described in further detail below, and stored in a table for that purpose such as WPPARKING_METERISSUES 75. Records in this table may be related to records in the WPPARKING_VENDOR_METERISSUETYPES table 74 to identify the type of issue for the particular report, and to a record in the WPPARKING_METERREPAIR table to identify the incident associated with the issue.

In order to facilitate the creation and keeping of a log of repair and other efforts relating to the incident, a log table may be created, such as WPPARKING_METERREPAIR_LOG 76, wherein each record in the log table represents an event (or “status”) in connection with the incident related to such log entry record. The relation between log records and incident records is shown in FIG. 6 as being one to many (i.e., each incident in the may have several related log entries) so as to facilitate a journal-like chronology of events. For example, A single incident for a meter might have three log entries: (1) “examined meter and determined power supply was defective”; (2) “checked inventory for replacement power supply but found none, ordered replacement”; and (3) “received replacement power supply and replaced same, meter tested ok”. Alternatively, records in the log table and incident table may be related in a many to many relationship as previously discussed.

Still other information relating to lots, lot grouping definitions and repair priorities, among other information, may be stored in the database module 10. For example, each lot may be given an absolute repair priority so that repair efforts may be prioritized when necessary. For instance, if meters in lots A and B are concurrently broken, the present system may refer to priority information for each and utilize repair resources first on the lot with the higher absolute priority. Thus, if lot A had a priority value of 5 and lot B a priority value of 6, then the system would seek to apply repair resources to lot B first (or vice-versa, depending on whether higher or lower priority values have been defined as having priority). In the preferred embodiment, this information is maintained in WPPARKING_METERREPAIR_LOTS table.

Lots may be divided into logical groups and/or regions. The system may utilize a table to store this information such as WPPARING_METERREPAIR_LOTGROUPDEFS 79. Individual lots as defined in table WPPARKING_LOTS 70 are assigned to lot groups via WPPARKING_METERREPAIR_LOTS 78, which acts as a relation table between the two tables.

The system of the present invention may also store information relating to payment options for broken meters, as will be described in further detail below. The different types of payment options may be stored in WPPARKING_METERREPAIR_PMTOPTIONTYPES table 120. These types may then be associated with one or more individual lots via a relation table such as WPPARKING_METERREPAIR_LOTS table 77.

The foregoing discussion of database structure represents only one of numerous database structures which may be acceptable for implementing the instant invention. For example, certain attributes of individual lots may alternatively be associated with groups of lots by application of appropriate table to table record associations.

Next, a meter out of order interactive voice response (“IVR”) module 12 provides voice recognition and process functionality for the system. By means of the functionality provided by the IVR module 12, the system is able to interact with various users by means of ordinary voice means, for example, via telephone, thus eliminating the need for dual tone multi frequency (“DTMF” or “touch tone”) based interaction, although DTMF interactions may also be supported by the system via the IVR module 12 or some other module. The IVR module may be any suitable host computer, whether shared or dedicated, or similar device and may utilize commercially available software and/or hardware based systems for such purpose, including, among others, Dialogic IVR related Hardware (Dialogic Communications Corp., 730 Cool Springs Boulevard Suite 300 Franklin, Tenn. 37067), Pronexus IVR related software (Pronexus, 750 Palladium Drive, Suite 200 Ottawa, Ontario K2V 1C7), Intel Pentium IV based servers running Microsoft Corp. Windows 2000.

As will be described in further detail below, the IVR module 12 interacts with parking customers, parking lot staff, field technicians, parking lot managers and parking lot enforcement personnel to provide information to such users and to receive information from such users regarding the status of parking meters, parking spaces, lots, user validation and payments and the like, and to update other system with such information by means of the various other system modules described herein.

Payment system module 14 provides payment processing functionality to the system of the instant invention, as will be described in further detail below. Payment system module 14 may be any suitable host computer, whether shared or dedicated, or similar device and may utilize commercially available software and/or hardware based systems for such purpose.

The various modules described herein, as well as other modules which may be included to provide additional functionality to a system of the instant invention, may communicate with each other by means of any suitable communications network as will be readily understood by those of ordinary skill in the art. Intra-system communication networks may include, among other, a local area network (“LAN”), wide area network (“WAN”), cellular radio networks, the internet, or any combination of these and/or others. In a similar manner, extra-system communications, for example, communications between the system and banking institutions for payment processing, parts suppliers for ordering replacement parts to effectuate repairs, and the like, may also be facilitated by the aforementioned network types. Also, self reporting devices, that is, devices programmed to self monitor and communicate directly with the present system, may also communicate using any appropriate data network.

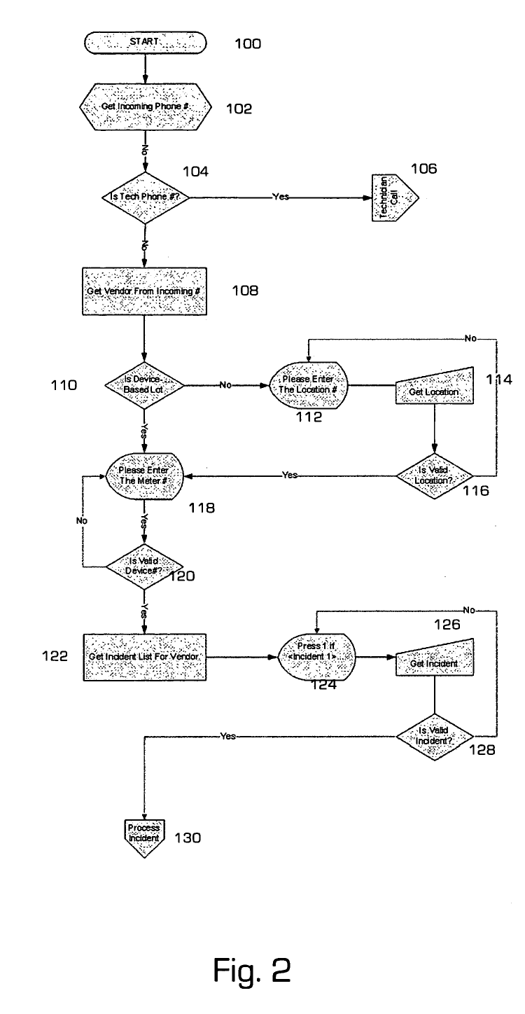

Turning next to FIG. 2, a meter out of order process flow of a preferred embodiment of the present invention is disclosed. In general terms, the flow depicted handles a report of an issue with a meter, that is, a report that a meter is not functioning correctly. Such a call may be initiated by anyone, including, among others, end users (i.e, those wishing to park), lot employees, lot managers, and repair technicians.

The process begins when the system when a call is received by the system, 100. The call may be via any communications channel supported by the system, including, but not limited to: telephone base channels, which may be handled by the IVR module previously discussed; computer based communications such as internet communications, which may be handled by an IVR-like module which provides appropriate interactive functionality, e.g, by means of a web-based interface utilizing HTML and/or scripted forms; or any other communications means which provides adequate two-way communications. Separately or collectively, these modules may be called Customer Interface Modules, and it should be understood that the IVR module 12 may act as a Customer Interface Module, providing several different customer interfaces such as those described here and others.

After receiving the incoming call, the system first determines the identifier of the incoming caller in step 102. The identifier may be a telephone number for the incoming call, in the case of a telephone based call (using caller-id service provided by various telephone service providers, e.g.), an internet protocol address, network adapter “mac” address in the case of network based calls, a device id in the case of a self reporting device, or user id's assigned to individual users by the system or system administrator, the entry of which may be prompted by system during step 100 or 102, as will be readily understood by those of skill in the art. Additionally or alternatively, any other identifier may be used so long as it sufficiently identifies the caller for the purposes disclosed herein. As the foregoing makes clear, a “caller” need not be a telephone caller, but refers to any entity or device initiating contact with the system as described.

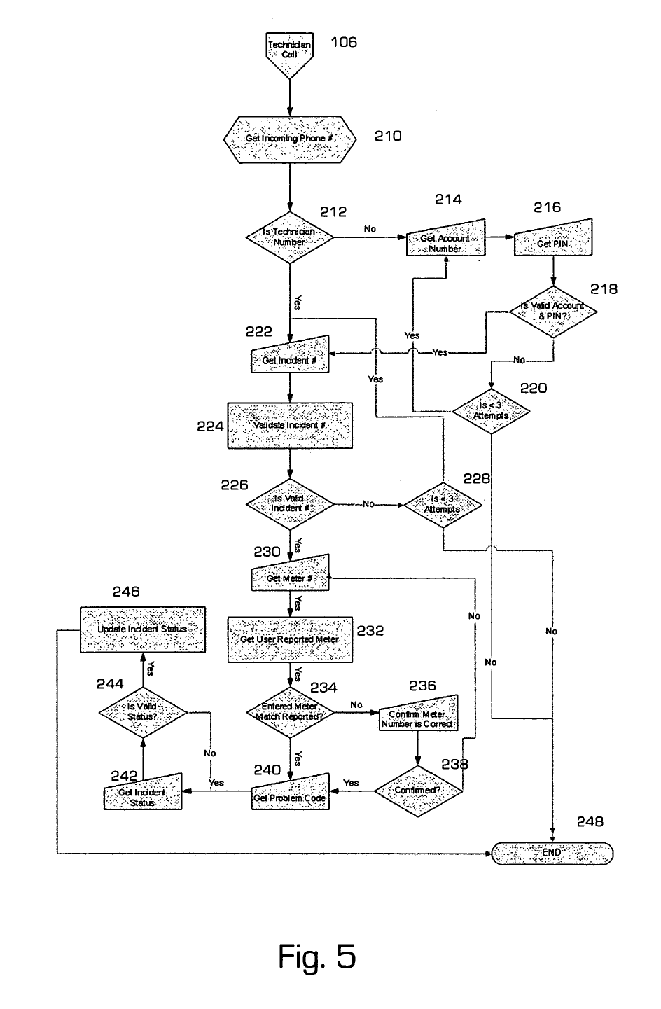

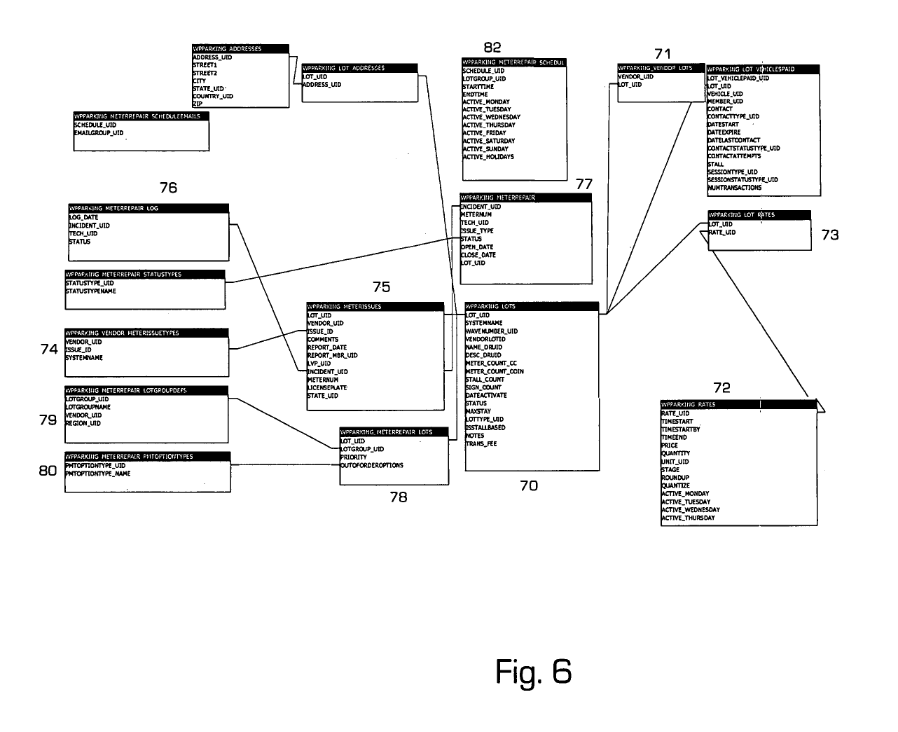

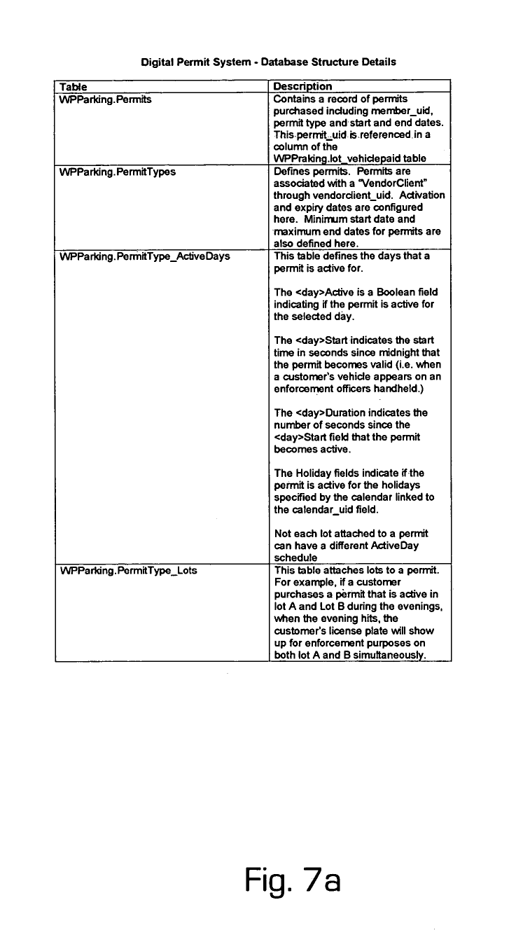

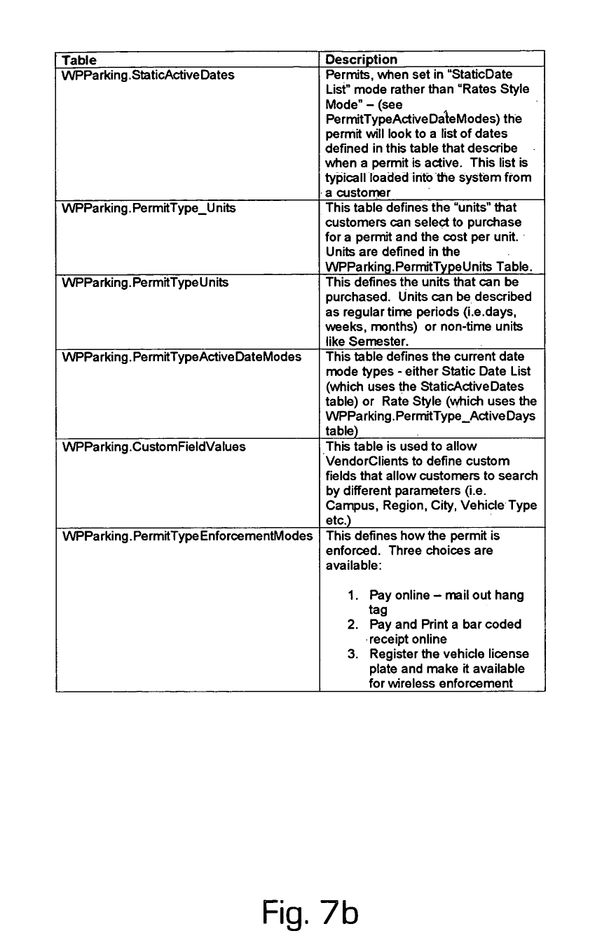

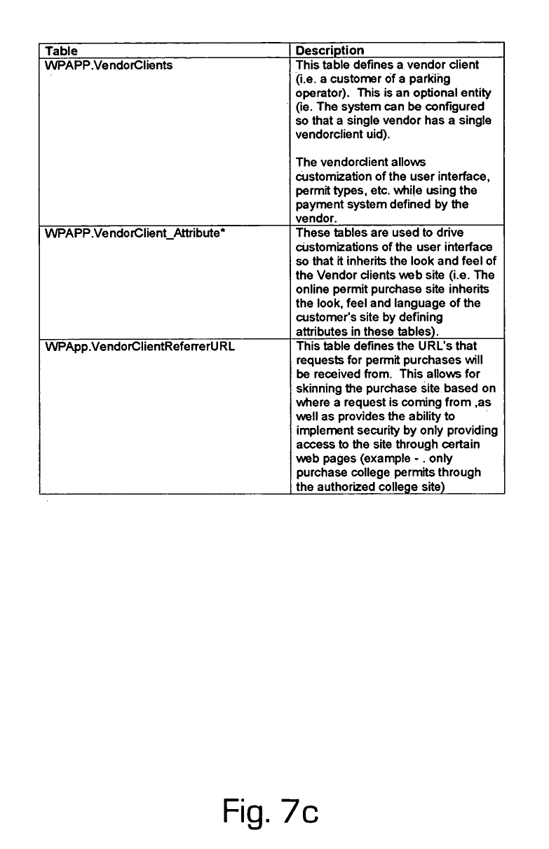

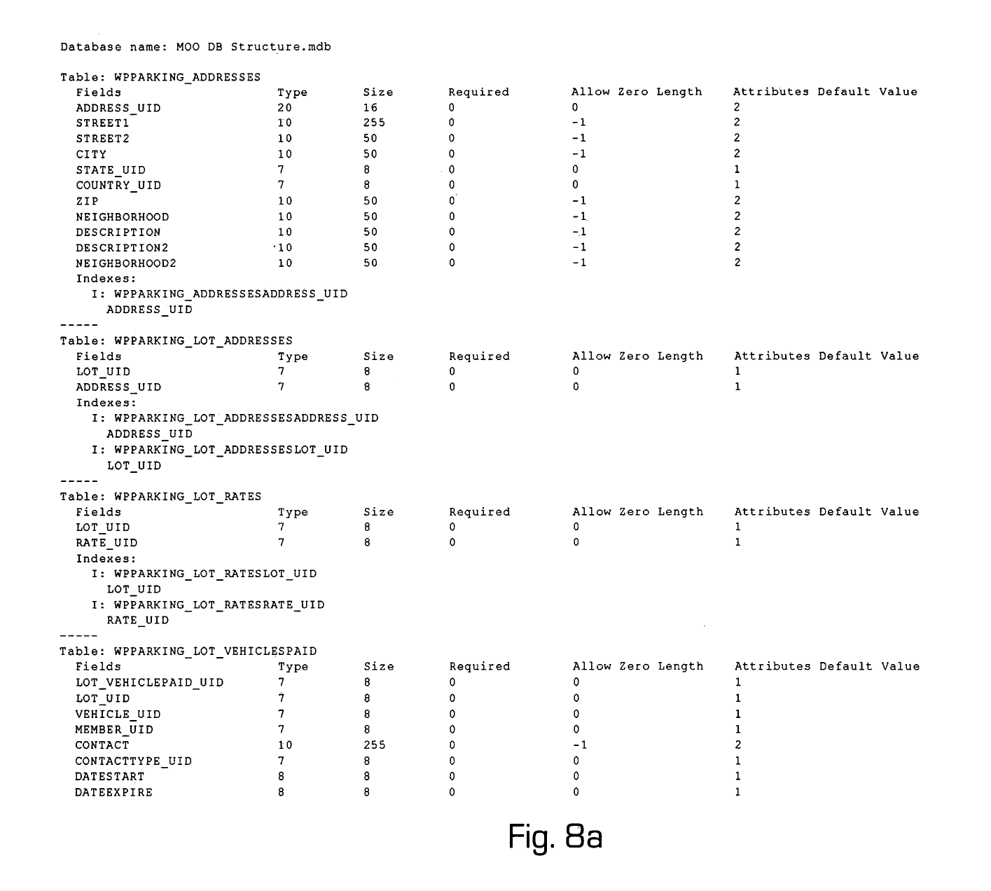

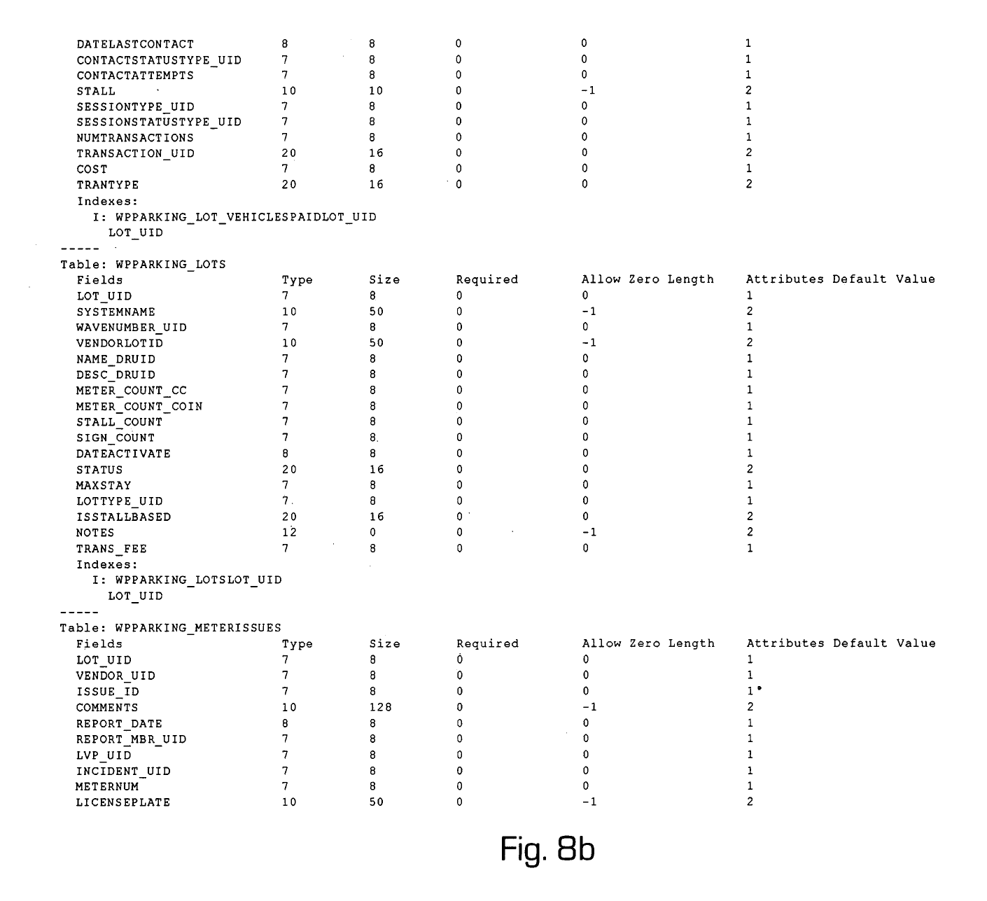

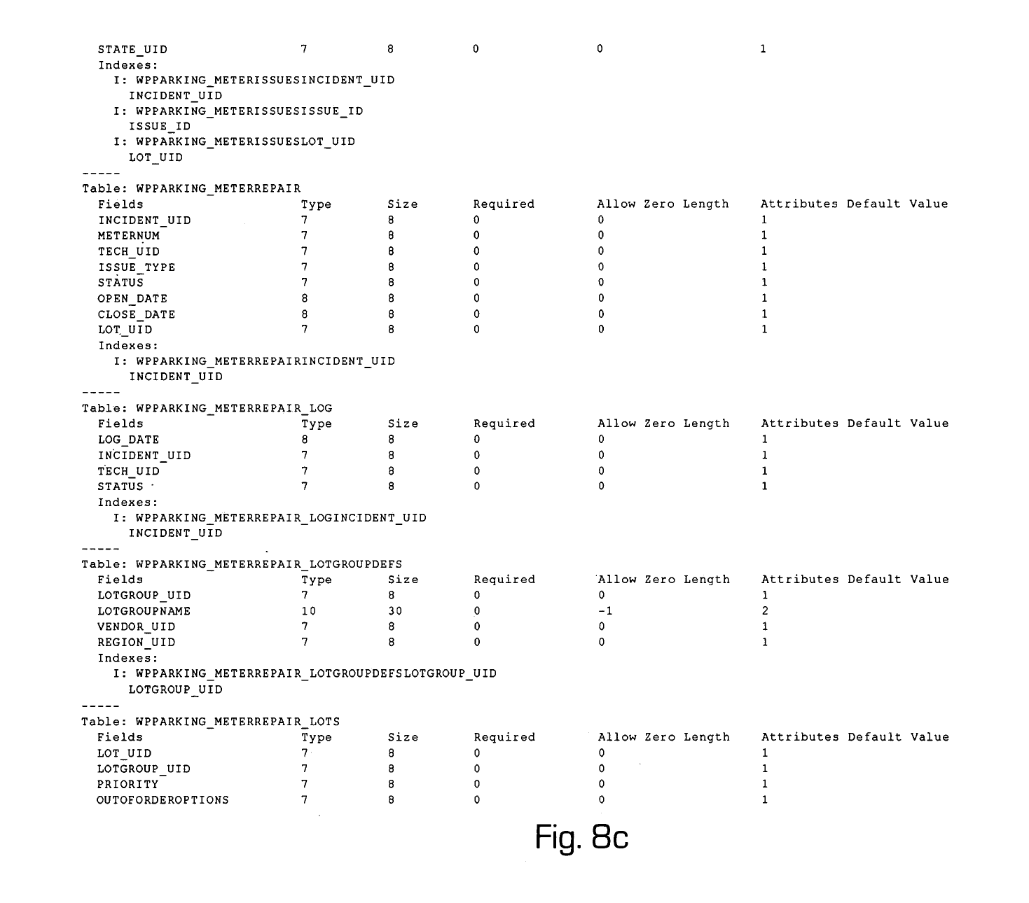

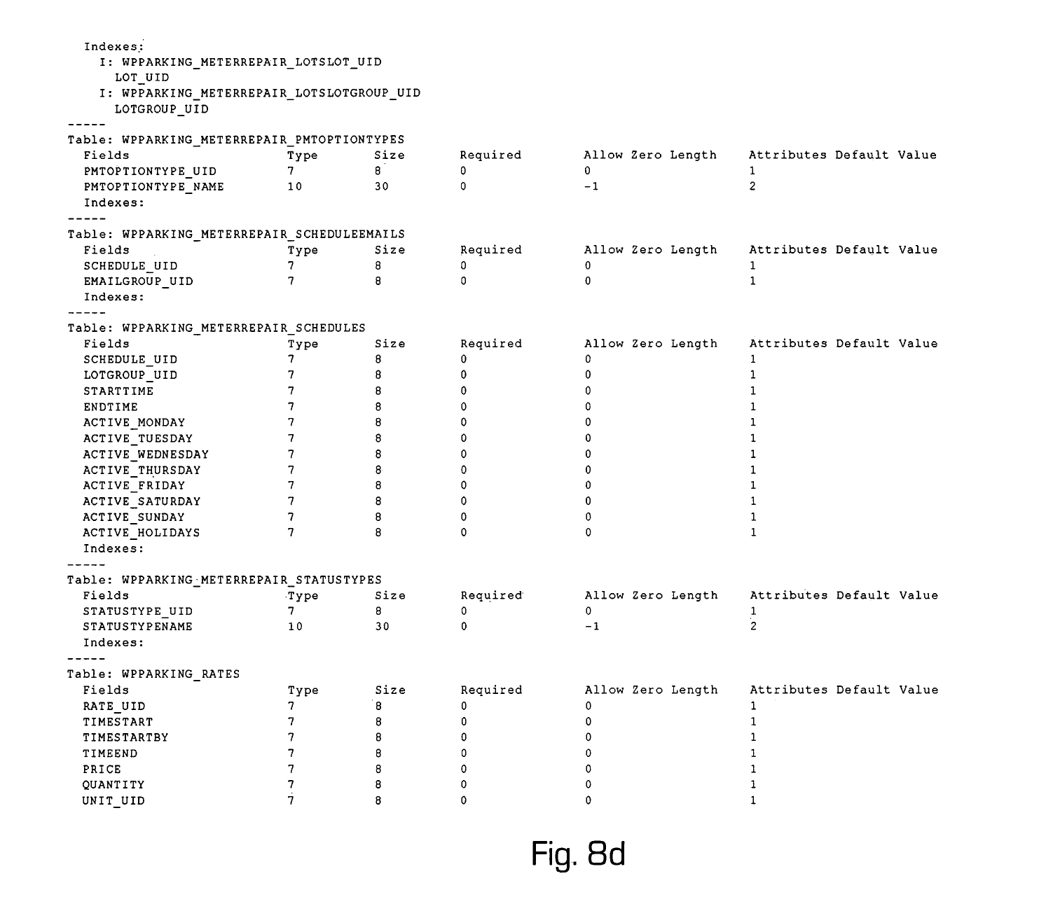

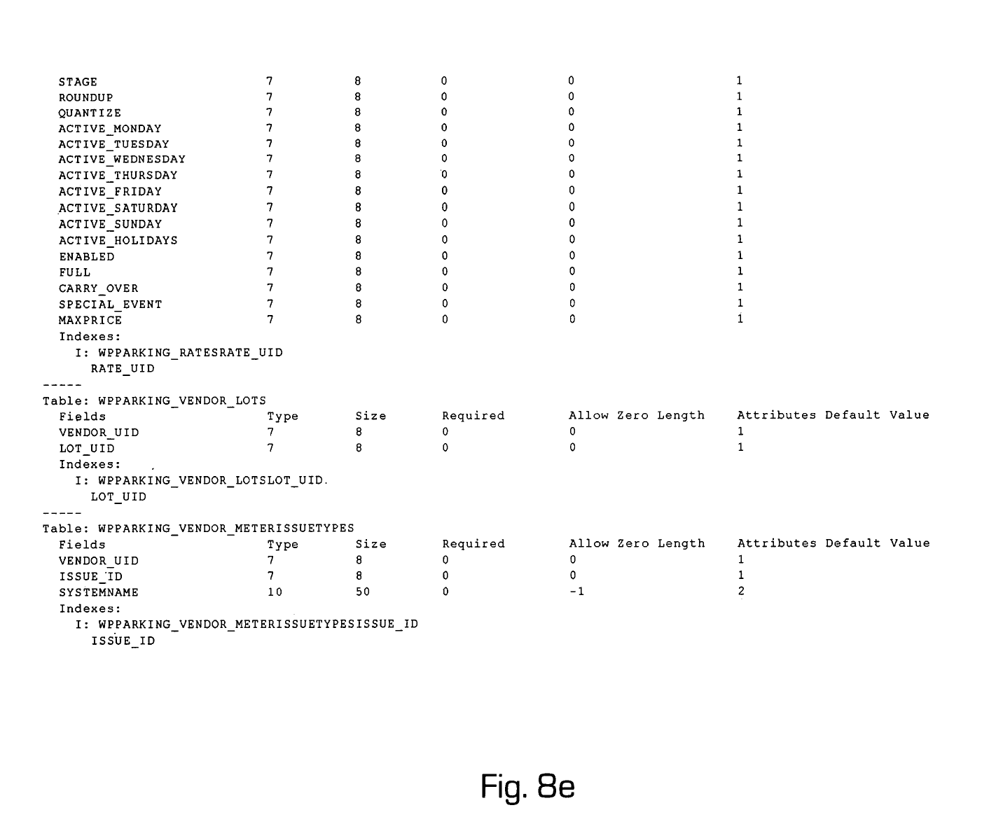

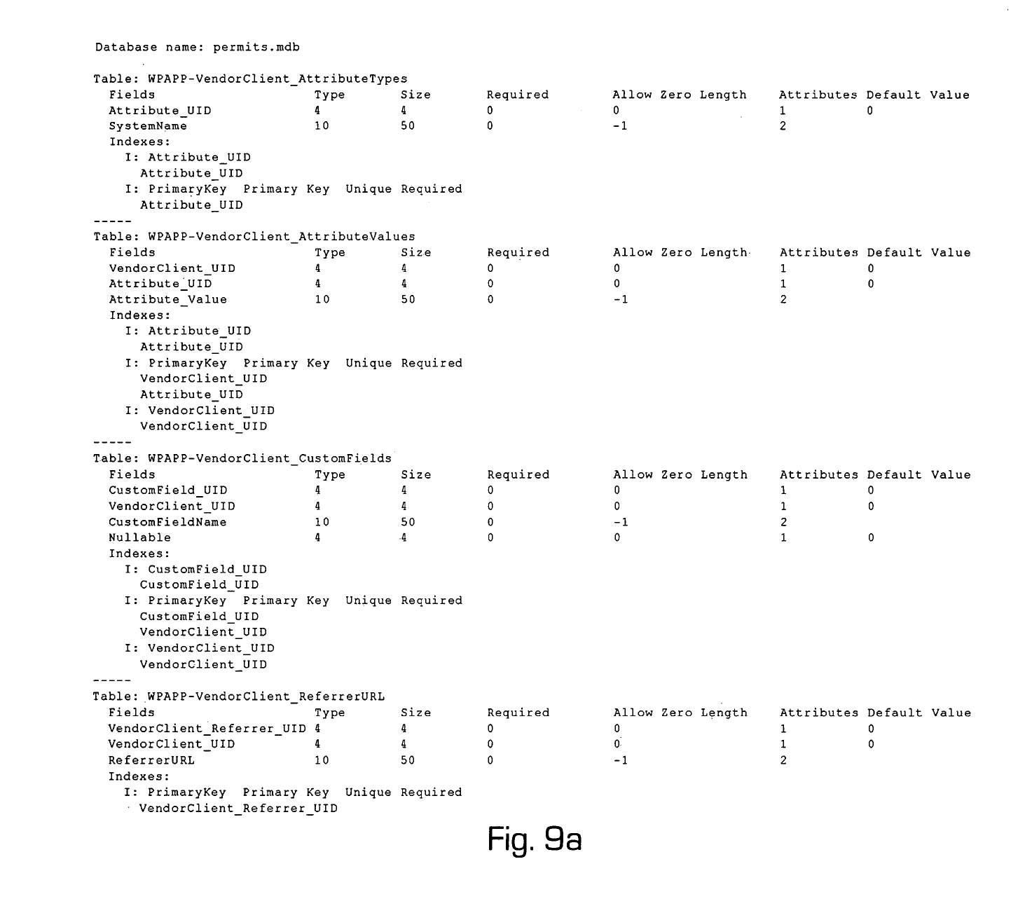

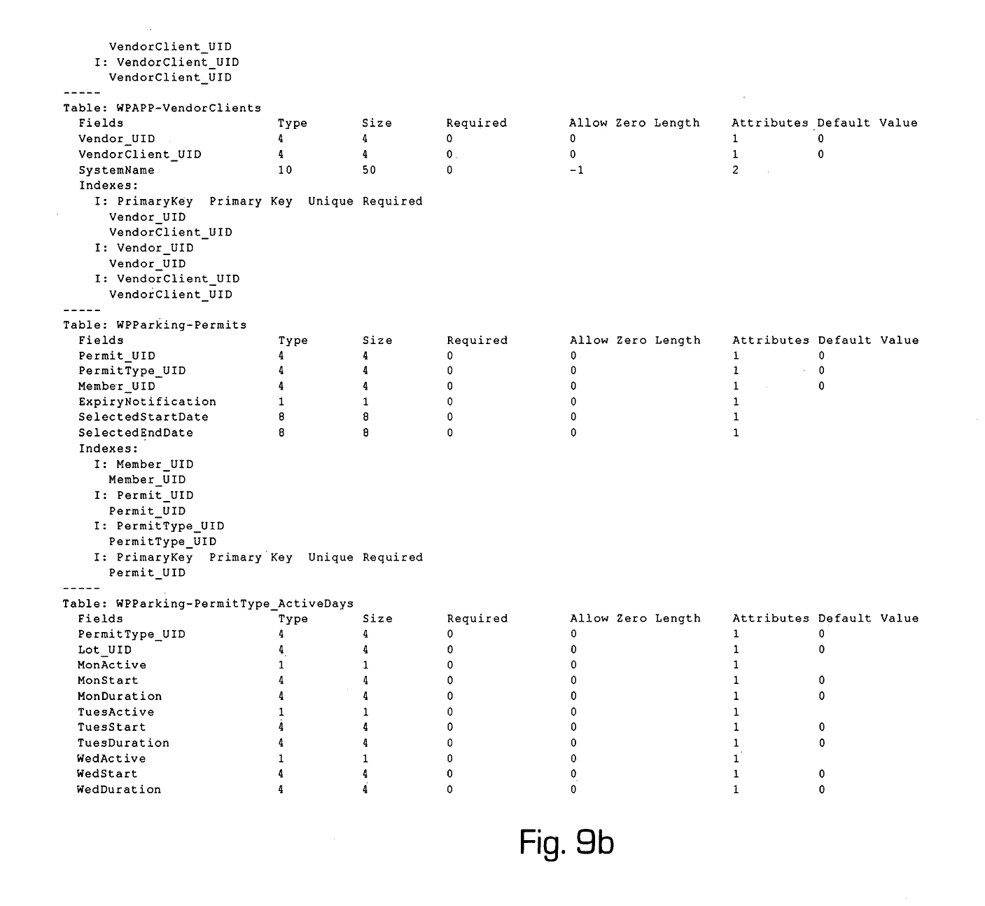

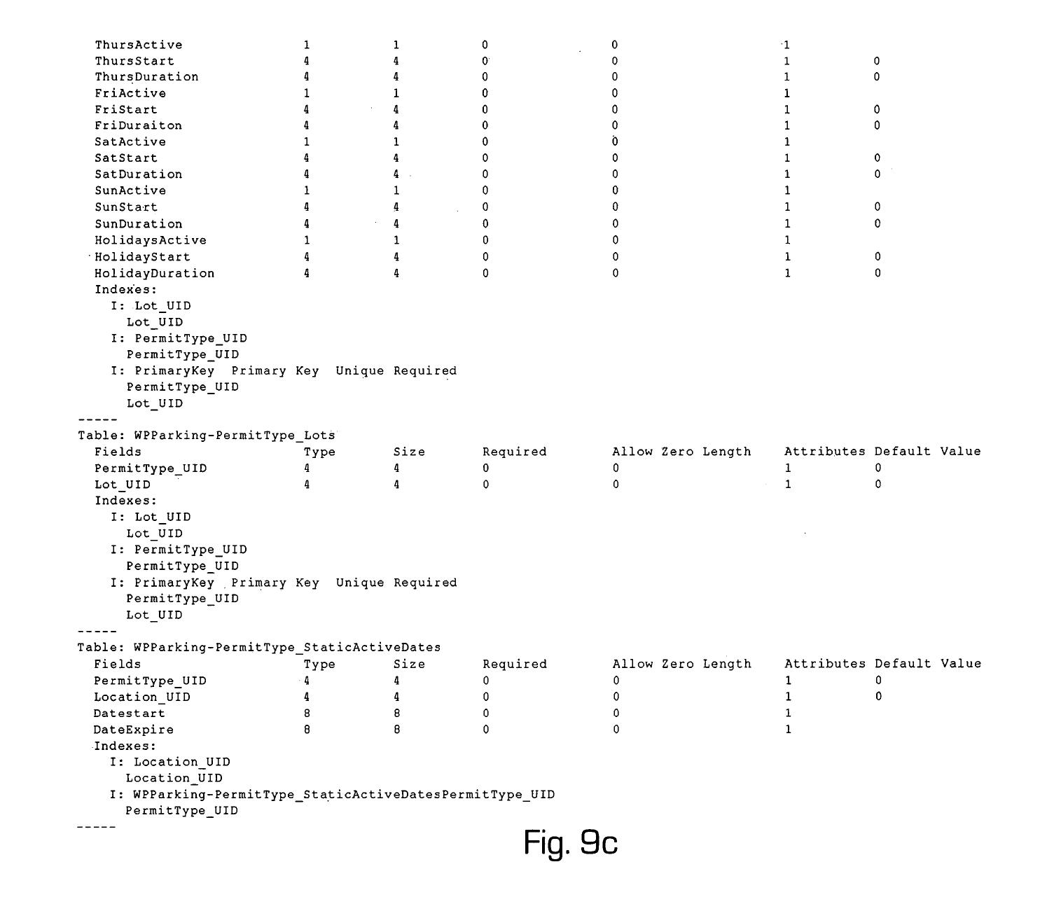

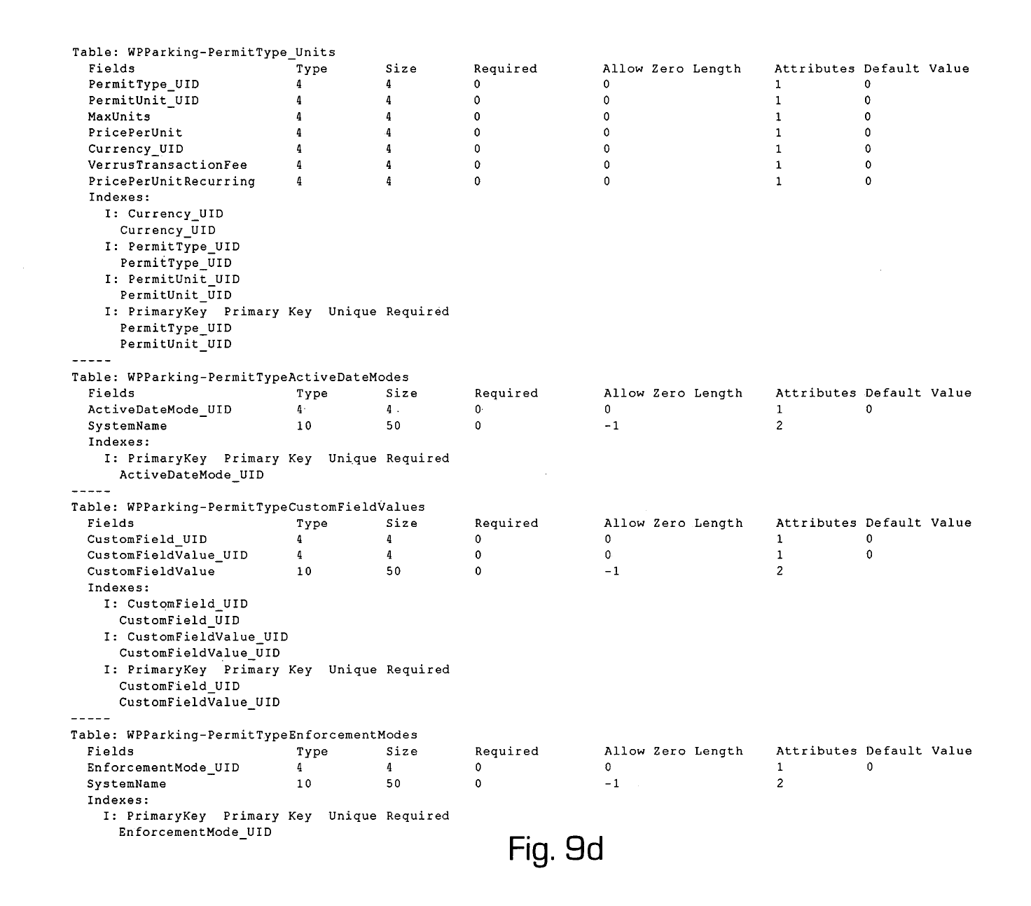

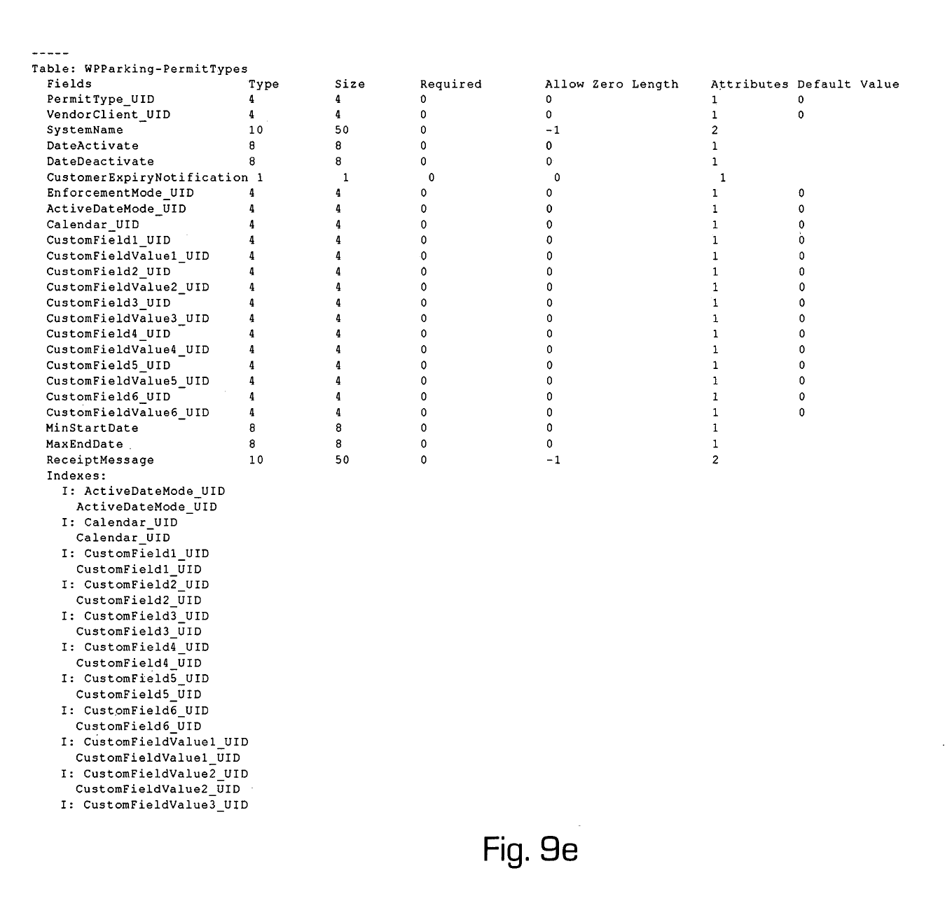

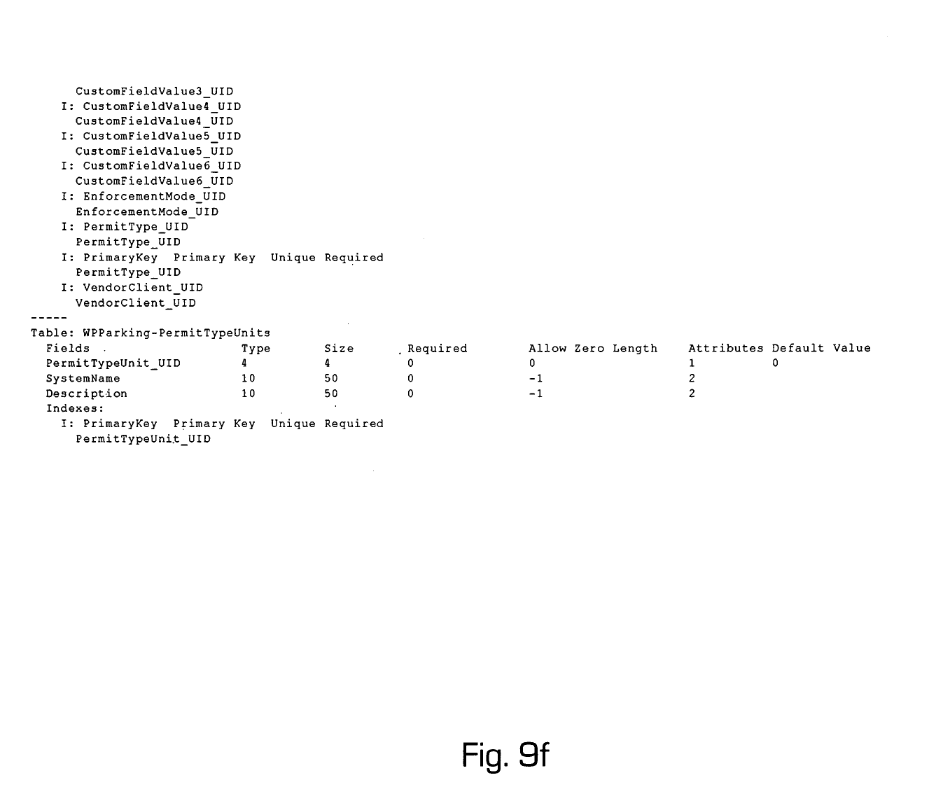

Upon obtaining the identifier of the incoming caller in step 102, the system may validate the identifier against identifier information maintained by the system, for example, in the meter out of order data module 10 or other similar data module implemented by the system in whole or in part for such purpose. Next, the system may determine whether the identifier is that of a service technician or self reporting device, indicating that the call is by a technician for purposes of updating the status of an incident. In such instances, the system begins processing the technician's or device's call in step 106, as will be discussed in detail in connection with FIG. 5. Otherwise, calls from non-technicians or devices, that is calls from end users, continues. Calls from unknown identifiers, for example, from unknown telephone numbers, may be presumed to be from users calling to report an issue with a meter.

The system continues the processing in step 108 by next ascertaining the lot associated with the issue being reported. This is necessary when the system of the present invention is implemented to permit both “device based” and “location based” lots. “Device based” lots are those which include a meter device for each parking space on the lot. “Location based” lots are those which do not include a separate meter device for each space, for example where “Muni-Meter” type devices are in use.

Once the system has identified the lot at issue, the system next determines whether the lot is device based or location based in step 110. This may be accomplished by obtaining the relevant data for the lot from the database module 10. If the lot is location based, the system may determine both the location at which the caller is parked (for possible later payment processing, as will be discussed in detail below) and the identity of the malfunctioning device. The first of these two determinations is achieved in steps 112 and 114.

First, in step 112 the system prompts the caller to enter the location identifier for the location in which he or she is parked. This may be a space number, which may be marked directly on the space with permanent paint-type materials or on a sign or other posting associated with the space. Alternatively, location identifiers may be space non-specific, as in implementations where “locations” are identified by the vehicle parked therein, for instance, by license plate number. In-this alternative identifier scheme, a space with a vehicle with New York license plate 123-456 might have an identifier of “NY123456” while that vehicle is parked therein. So long as an identifier sufficiently identifies a space so that enforcement officers can determine the payment status of the space, the identifier is sufficient. Any identification scheme meeting this minimum requirement will suffice.

After obtaining the location identifier in step 1 12, the system obtains the location identifier from the caller by appropriate means based on the channel through which the call is being made. This may include, for example: via voice recognition implemented by the IVR module 12 in the case of voice telephone calls; DTMF input in the case of other telephone calls; web based or other computer implemented user interface in the case of computer based communications; a predetermined communications protocol in the case of a self reporting device; and others.

The system then validates the location as provided by the caller in step 1 16. This may be accomplished by querying database module 10 for information regarding the identifier provided by the caller. The system may use the information contained in database module 10, for example, to determine whether the location number provided by the caller exists at the lot in question. Alternatively, in space non-specific lots, the system may simply accept the identifier provided, or may seek to validate it against a “black list” of identifiers considered invalid by the system (for abusively used identifiers, for example), or against an external database of valid identifiers, e.g, a database of valid license plates, vin's or the like.

Where the validation step 116 returns an invalid result, the system may return to step 112 to re-prompt the caller to enter an identifier, or may exit. The decision to return to step 112 or exit maybe based on the number times step 116 had been reached for the caller in question, or may be based on other conditions, as well as being condition independent. Where validation step 116 returns a valid result, the system may proceed to step 118.

Next, in step 118, the system queries the caller for the identity of the malfunctioning device. Where the system determines in step 110 that the lot in question is device based, step 118 may immediately follow step 110. The device is the identifier of the meter device directly associated with some parking space in device based lots, and a “Muni-Meter” type device used in association with the lot in question in location based lots. In either event, the system, may retrieve the device identifier in substantially the same manner as described above for the location identifier. After retrieving the device identifier from the caller, the system determines if the identifier is valid in step 120 by querying the database module 10, for instance. The system may use data about the lot in question to determine if the identifier provided by the caller refers to a device associated with the lot in question.

Where the validation step 120 returns an invalid result, the system may return to step 118 to re-prompt the caller to enter an identifier, or may exit. The decision to return to step 120 or exit may be based on the number times step 120 had been reached for the caller in question, or may be based on other conditions, as well as being condition independent. Where validation step 120 returns a valid result, the system may proceed to step 122.

After the device identifier for the malfunctioning device is determined, the system may attempt to determine the type of issue being reported by the caller. First, in step 122, the system obtains a list of valid issue types for the lot in question. This may be accomplished by querying the database module 10 for a list of valid issue types based on lot owner, lot identifier, or the like, as discussed above in connection with the meter out of order database structure disclosed in FIG. 6.

The system next may present to the caller in step 124 the list of valid issue types so that the caller may select the most appropriate issue type to describe the malfunction as understood by the caller. The form in which the system presents the list to the caller depends largely on the communications channel through which the caller is interacting with the system. For example, if the communications channel is a voice telephone call, the user may be presented with a voice a verbal list of issue types, or as previously discussed in other contexts, the system may use web based user interfaces and the like to present the list to the caller. In step 126, the system may use voice recognition via IVR module 12 or DTMF processing to obtain responses to the verbal list from the caller, as previously described in other contexts, or other input processing means appropriate to the communications channel being used.

The system next determines in step 128 whether the issue entered by the user is valid, for example, whether the DTMF key pressed is within the range of allowable responses. If the issue input by the caller is not valid, the system may return to step 124 or may exit in much the same manner as that described above in connection with steps 116 and step 120.

Once the system has validated the issue entered by the caller, the system proceeds to step 130 to begin processing of the issue.

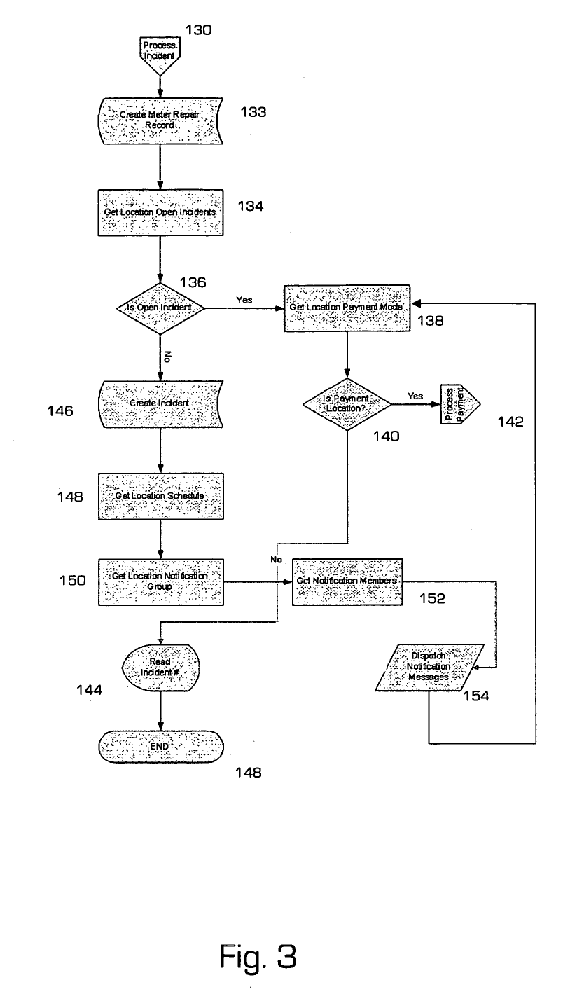

FIG. 3 depicts the system flow of issue processing of a preferred embodiment of the present invention. The system first creates and populates a newly created record in the WPPARKING_METERISSUES table 75 and related tables in database module 10, representing the reporting of an issue with a particular meter device. Based on the information collected by the system while processing the call that triggered the issue, the system populates the various fields of the meter issue record and related tables, including, for example, the issue type, the date of the call, the device identifier, the state and number of the caller's vehicle license plate.

Next, the system determines in step 136 whether the currently reported issue represents a “previously opened incident” or “new incident”. “New incidents” are created when an issue is reported for a meter device which the system lists as being in an operative state; i.e., a working device. By contrast, issues reported for a device already listed as being malfunctioning are considered “previously opened incidents”. Stated differently, a “new incident” is created the first time a device in a functioning state is reported malfunctioning, while subsequent reports of the malfunctioning state of the device do not create a “new incident”, as the incident is already considered “opened”. In a similar vein, an incident is “closed” when a malfunctioning meter, i.e, one for which an incident has previously been opened, is deemed repaired. After a meter incident is closed, a subsequent report of an issue would trigger the opening of a new incident, not reopen an earlier incident.

Where a reported issue requires the creation of a new incident, the system does so in step 146 by populating a newly created record of the WPPARKING_METERREPAIR table 77 and related tables of the database module 10. This record or records are populated with information including, for example, the device number, the status, the date the incident is opened and the like.

Thereafter, the system may attempt to notify appropriate entities of the new incident. This process begins in step 148, where the system retrieves technician information for the lot containing the malfunctioning device from database module 10. The database module 10 may maintain information regarding individual technicians and/or groups of technicians who may be associated with one or more individual lots and/or groups of lots. Furthermore, the database module may maintain schedule information for various individual technicians and/or groups of technicians, thereby permitting the system to identify not only which technician or group of technicians to notify based on lot, but also based on the time and day/date of the incident. In other words, the system can determine what technician or group of technicians should be notified for any particular lot at any particular time and date.

After determining the proper technician or groups of technicians to notify about a new incident, the system retrieves in step 152 notification information for the technician or technicians previously identified. Notification information may include both the type of notification, e.g., pager, telephone call, instant message, email and the like, as well as the address of the notification, e.g., the email address, pager or telephone number, instant message identity and the like. Once this information has been retrieved, the system may dispatch the message or messages, as will be readily understood by those of skill in the art, in step 154.

For each issue reported, whether a new incident or previously opened incident, the system may determine whether the lot in question has been specified as a location requiring payment by alternative means in the event of a device malfunction (a “payment required location”) or whether end users are permitted to park without making payment in such situations (a “payment not required location”). This process begins in step 138, when the system queries the database module 10 for the payment mode for the lot in question, i.e., whether the lot in question is a payment required location or a payment not required location. If the lot in question is a payment not required location, the system may proceed to provide the caller with incident identification information in step 144 so that the caller may, for instance, write down the incident number and display it in his or her vehicle's windshield so that enforcement officers may be informed that no payment is required from the caller. Similarly, if the caller is a self reporting device, no payment need be made, and processing may stop.

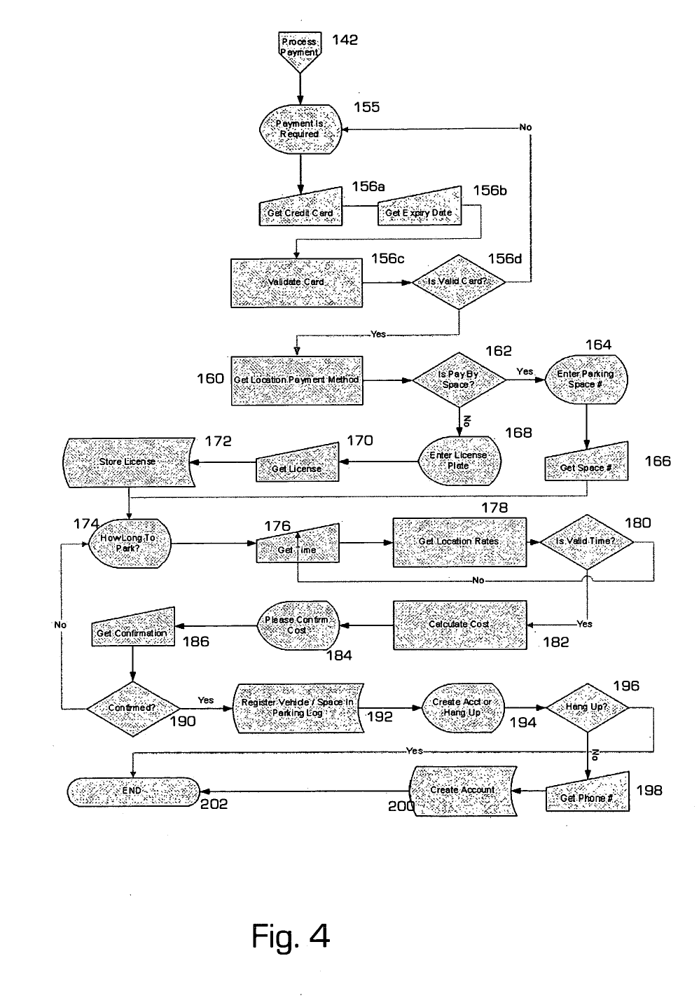

If, on the other hand, the lot in question is a payment required location, then the system begins at step 142 the task of processing payment, depicted in FIG. 4. First, the system informs the caller in step 155 that payment is required. This information is conveyed to the caller in a manner appropriate to the communication channel of the call, e.g, by voice prompt for voice telephone calls or by presenting an HTML or other page on a computer screen for a computer based call. As is well known in the art, the system in steps 156a thorough 156d then obtains credit card information, including credit card number and expiry information from the caller and validates the information using well established automated or manual credit card validation and/or processing means. These steps may be repeated if validation fails.

After successful validation, the system queries the database module 10 to determine the payment method for the lot in question, that is, whether the lot in question utilizes a “pay by space” or “pay by vehicle” payment method. A “pay by space” payment method is one in which payments are associated with a particular space, while a “pay by vehicle” method is one in which payments are associated directly with particular vehicles regardless of in which space they are parked.

If the results of the query regarding payment method indicate a pay by space methodology, the system proceeds to step 164, in which the system prompts the user for the parking space identifier identifying the space in which the caller is parked. This prompt is provided and response received in a manner appropriate to the communication channel of the call, as has been discussed previously in different contexts. If the results of the query regarding payment method indicate a pay by vehicle methodology, the system prompts the user in step 168 for vehicle identification information such as license plate state and number, vin or the like, and receives the response from the caller. This prompt, too, is provided and response received in a manner appropriate to the communication channel of the call, as has been discussed previously in different contexts. Finally, for pay by vehicle payments, the system queries the database module 10 with the vehicle identification information received from the caller to screen for caller abuses, and the vehicle information is stored in the appropriate tables in the database module 10 for future reference.

Regardless of payment methodology, the system in steps 174 and 176 next prompts for and receives from the user the desired parking duration, as has been described previously in other contexts. Upon receiving the response from the caller, the system in step 178 next queries the database module 10 for the rules defining the permitted parking hours and/or durations. The system may also query the in step 178 for applicable parking rates, although parking rate information may be obtained at a different time, provided it is prior to cost calculation step 182. The system in step 180 then calculates whether the duration requested by the caller in step 176 exceeds any maximum time limitation and/or any time of day parking regulation (e.g., “no parking after 5:00 p.m.”). If the system determines in step 180 that any parking rule or rules would be exceed by the requested duration, the system loops to step 174 to request a new duration from the caller.

Once a valid duration has been received by the system, processing continues with step 182, where system calculates the total cost for the requested duration based on the previously obtained rate information. The system then, in steps 184, 186 and 190, prompts the caller, as has been described previously in different contexts, to confirm the transaction, and receives the response from the caller, also as previously described in different contexts. If the caller fails to confirm, the system returns to step 174, otherwise the system continues to step 192, where it may store information regarding the transaction, including payment details, vehicle information and lot information in appropriate tables in the database module 10.

Finally, in step 194, the system may ask the caller if the caller desires to create an account in the system. If the caller answers in the negative or hangs up, processing may terminate at step 202, otherwise processing proceeds to step 198, where the system queries the caller for account related information such as name, vehicle information and telephone number. The information is the stored in appropriate tables in the database module 10. The processing may then terminate at step 202.

FIG. 5 discloses a flowchart for technician call processing of a preferred embodiment of the present invention. The process begins, after initial step 106, at step 21 0, where the system obtains the incoming telephone number of the caller utilizing caller id or similar technology, as will be readily understood by those of skill in the art. Alternatively, the system may obtain different identifiers for the call depending on the communications channel being utilized. For example, if the call is being made from a computer type device via a data communications network, the identifier for the call may be an internet protocol or mac address for the calling device.

The system then in step 212 queries the data server module 10 to determine if the incoming telephone number is that of a technician, that is, a caller authorized by the system to update the status of a device. If not, the system in steps 214 through 218 attempts to validate the caller as a technician by first querying the caller for an identifier and/or password, and then validating this information against data maintained in the data server module 10. This may be accomplished in a manner substantially similar to that discussed in connection with step 102, FIG. 2.

Upon each failure to validate the caller in step 218, the system in step 220 may increment a counter and test the value of that counter against a pre-determined parameter signifying the maximum number of failed validation attempts permitted before terminating the call. If in step 220 the system determines that the maximum number of such attempts has been exceeded, the system may terminate the call by proceeding to step 248; if not, the system returns to step 214.

After validating the caller as a technician in-either step 212 or 218, the system continues processing in step 222 by requesting from the caller an incident identifier for the call. This request is provided and response received in a manner appropriate to the communication channel of the call, as has been discussed previously in different contexts. In steps 224 and 226, the system attempts to validate the incident identifier received from the caller. This may be accomplished in substantially the same manner as previously described for technician validation in steps 214 through 220, including determining in step 228 if a maximum number of failed attempts at inputting a valid incident identifier has been exceeded.

Upon validating the incident identifier,.the system then attempts to confirm in steps 230 through 234 that the device in question was properly identified by the end user who initially reported the malfunctioning device. This may be accomplished by prompting the technician for a device identifier in manner such as those previously discussed in other contexts, querying the data server module 10 for the device identifier associated with the current incident, and comparing the two. If these two do not match in step 234, the system may proceed to step 236 in which the system prompts the technician to confirm that the device identifier he or she has entered is in fact the correct device identifier. If this is not confirmed by the technician, the system returns to step 230.

If either the device identifiers match in step 234 or the device identifier entered by the technician is confirmed in step 238, the retrieves the problem code for the incident in step 240 and then prompts the technician for the status of the incident, that is, the new device status, in step 242. The system provides the prompts and receives the response in a manner appropriate to the communication channel of the call, as has been discussed previously in different contexts. The system then validates the response in step 244 by querying the data server module 10 with the status received form the technician to ensure that the status entered is valid for the lot in question, the vendor and the like. If the status entered is not valid, the system returns to step 242, otherwise the system updates in step 246 the incident status in the data server module 10 before terminating in step 248.

While particular embodiments of the present invention have been shown and described, it will be apparent to those skilled in the pertinent art that changes and modifications may be made without departing from the invention in its broader aspects.

What is claimed is:

1. A meter out of order monitoring and repair system comprising:
a customer interface module and a data module, wherein said customer interface module performs the steps of: (i) receiving a call from a caller concerning a malfunctioning meter; (ii) determining if said call is from a technician or from a device or user; (iii) determining a type of said malfunction or determining a status change; and (v) processing payment information from said caller.
